(19) United States
(12) Patent Application Publication
(10) Pub. No.: US 2016/0091092 A1
(43) Pub. Date: Mar. 31, 2016

(54) DEFORMABLE ALL METAL GASKETS FOR ULTRA HIGH PURITY SEALING

(71) Applicant: Atlas Bimetal Labs, Inc., Port Townsend, WA (US)

(72) Inventors: Justin C. Bothell, Port Townsend, WA (US); Richard D. Bothell, Sequim, WA (US); Austin L. Henry, Port Townsend, WA (US)

(21) Appl. No.: 14/864,481

(22) Filed: Sep. 24, 2015

Related U.S. Application Data
(60) Provisional application No. 62/055,058, filed on Sep. 25, 2014.

(51) Int. Cl. F16J 15/08; B65D 53/00

(52) U.S. Cl. CPC F16J 15/0881; F16J 15/0806; B65D 53/00

(57) ABSTRACT

A metal gasket made of soft, malleable metals such as aluminum, copper, or shape memory metals formed with specified deformable geometric features that enable the gasket to form ultra high vacuum or ultra high purity hermetic seals with very low permeation. These features permit a simple shape that may be used in unique grooves, conventional elastomeric o-ring grooves, or independently.

### REFERENCE TO RELATED APPLICATIONS

This application claims the benefit of and priority to U.S. Provisional Application No. 62/055,058 Entitled “Deformable All Metal Gaskets for Ultra High Vacuum and Ultra High Purity Sealing” filed Sep. 25, 2014.

### TECHNICAL FIELD

The invention relates to equipment and method of manufacture for metal gaskets to be used as drop-in replacements for elastomer O-rings used to seal vacuum vessels.

### BACKGROUND INFORMATION:

Elastomeric seals (polymers industrially known by many names such as Viton, Burna, Kalrez PTFE) are commonly chosen as the sealing gasket for vacuum chambers. They are often configured as O-rings installed in grooves that are captured between two faces which create a vacuum-tight seal. For low and high vacuum and low and high purity regimes, O-rings are cost-effective and reliable. However, O-rings polymers themselves are permeable and allow disruptive quantities of gasses and contaminants to enter the vacuum environment in the ultra-high vacuum (UHV) range and beyond. Furthermore, the inherent permeation in elastomeric compounds are consequential in ultra high purity (UHP) environments and may contaminate the environment. To operate in UHV or UHP, chambers must be built with special sealing flanges such as Conflat (CF) or Wire Seal flanges which have knife like edges that crush all-metal gaskets (typically copper or aluminum). These all-metal gaskets have little to no gas permeation and are required for achieve UHV and UHP. These CF and wire seal flanges are available in standard round sizes.

Not all UHV and UHP vessels may be sealed with conventional CF or wire seal flanges. When an opening is required in a chamber that is square or rectangular, too large, or oddly shaped, a special flange may be machined that deforms a soft foil (e.g., indium, tin) to create the requisite all-metal seal. Alternatively, 4 aluminum wires may be strung over a flat rectangular flange face such that they intersect at the corners, where the mating rectangular flange may then compress the wires with considerable force to create a suitable UHV or UHP seal. Each of these solutions is time consuming and expensive in material and requires a large space to properly execute.

There also are industrially available all-metal “C” shaped seals that may be used for UHV and UHP. They may also have a deformable metal ridge on the top and the bottom of the seal which improves their UHV functionality by yielding under the stress of compression. These C seals have an internal spring that energizes the seal and compresses it against the mating chamber surfaces. These C seals are unreliable and expensive. They are also not suitable for tight radii and do not readily fit already cut oring grooves.

There also are soft metal gaskets with deforming wedge shaped sealing edges which are fixed by an outer support frame. These support frames type seals come in two varieties. First, there are circular shaped locating frames fixed to the outside of the circular wedge shaped sealing edge. The locating frame is tube-like and suspends wedge shaped edges inside of either face of the tube. The second type has flat support frames that span outside the center plane of the deforming wedge-shaped sealing face. These support frames are plates of sheets of metal with bolt holes that provide the location for the wedge type seal relative to the bolts.

Both of these support frame type metal gaskets are machined from larger plates of a soft metal such as copper or aluminum and are consequently costly. All of these support frame type seals are restricted to sealing flat flange faces and do not fit into grooves like elastomeric o-ring grooves. If either the flat plate surfaces are damaged, the seal will not work.

There are no all-metal seals that offer the flexibility and versatility of elastomeric or polymer seals. There are many standard and non standard shaped flanges and ports such as rectangular, circular, oval, and hexagonal, and each geometry may vary widely in size being small or very large. Many may only be sealed with elastomeric seals or the crushed wire or foil method.

Accordingly, there is an as of yet unmet need in the art for deformable metal seals that may be used interchangeably with polymer elastomeric seals. There also is a need to upgrade existing chambers to UHV and UHP regimes by using all metal seals that fit standard elastomeric o-ring grooves.

### SUMMARY OF THE DISCLOSURE

An all-metal gasket system for sealing vacuum with very low permeation comprising a soft, malleable metal gasket of aluminum, copper, nickel, tin, silver, gold or other metal with a hardness of <70 Rockwell B Scale (100 kg 1/16″ Ball), a yield strength of 20 to 220 MPa and a vapor pressure of <1×10−8 Ton at 600 K. The gasket is extruded or machined into a specified shape and formed into a circular or otherwise continuous ring-shape with the same dimensions as the receiving O-ring groove. The gasket is designed with specific shapes for desired deformation properties. The existing O-ring is removed from the vacuum chamber and the deformable metal gasket is inserted into the groove. As the two opposing faces of the vacuum chamber are tightened down on the gasket, the gasket deforms and fills the O-ring groove in such a manner that there are no voids or pockets where gasses may transmit from the atmosphere side to the vacuum side. The gasket is crushed between the two sealing faces and now forms a UHV barrier.

The invention may be coated or treated in any manner (for example, nickel-plating or anodizing) to alter hardness or deformation properties. Additionally, advanced memory retention metals may be used to return the gasket to the pre-crushed state if removed by the user.

The invention creates a vastly less permeable vacuum seal in an existing O-ring groove than the original elastomer O-ring. Similar to other UHV sealing methods, the invention creates an entirely metal barrier between a vacuum environment and the outside atmosphere. The invention may be used as an upgrade of an existing vacuum chamber for UHV use without the need for re-machining or expensive physical alterations to the chamber.

### BRIEF DESCRIPTION OF THE DRAWINGS

The invention is described in more detail with reference to the attached drawings, in which:

FIG. 1 is a cross section view of a simple version of the all metal gasket before it is compressed between two plates;

FIG. 2 is a cross section of the metal gasket in an unused form in a conventional dovetail shaped elastomeric o-ring groove;

FIG. 3 is a cross section view of the metal gasket when installed and crushed in a typical O-ring groove;

FIG. 4 is cross section view of the uncompressed gasket with one compressive force limiter cut out per side. This also serves as a volume that captures the displaced deformed metal when the gasket is compressed;

FIG. 5 is a section view of the uncompressed gasket showing two cut-out reliefs per side of the gasket that are located on the 60 degree slip planes of deformation;

FIG. 6 shows a narrower embodiment of the uncompressed gasket held between two flanges with grooves;

FIG. 7 shows the joint of two ends of an extruded gasket forming a continuous hermetic ring; and,

FIG. 8 shows an alternate version of the all metal gasket that is a hybrid between a conventional sheet meal Conflat style gasket and the all metal seal disclosed in this patent.

### DETAILED DESCRIPTION

The following detailed description illustrates the invention by way of example, not by way of limitation of the scope, equivalents or principles of the invention. This description will clearly enable one skilled in the art to make and use the invention, and describes several embodiments, adaptations, variations, alternatives and uses of the invention.

In this regard, the invention is illustrated in the several figures, and is of sufficient complexity that the many parts, interrelationships, and sub-combinations thereof simply cannot be fully illustrated in a single patent-type drawing. For clarity and conciseness, several of the drawings show in schematic, or omit, parts that are not essential in that drawing to a description of a particular feature, aspect or principle of the invention being disclosed. Thus, the best mode embodiment of one feature may be shown in one drawing, and the best mode of another feature will be called out in another drawing.

### Deformable All Metal Gaskets for Ultra High Vacuum and Ultra High Purity Sealing

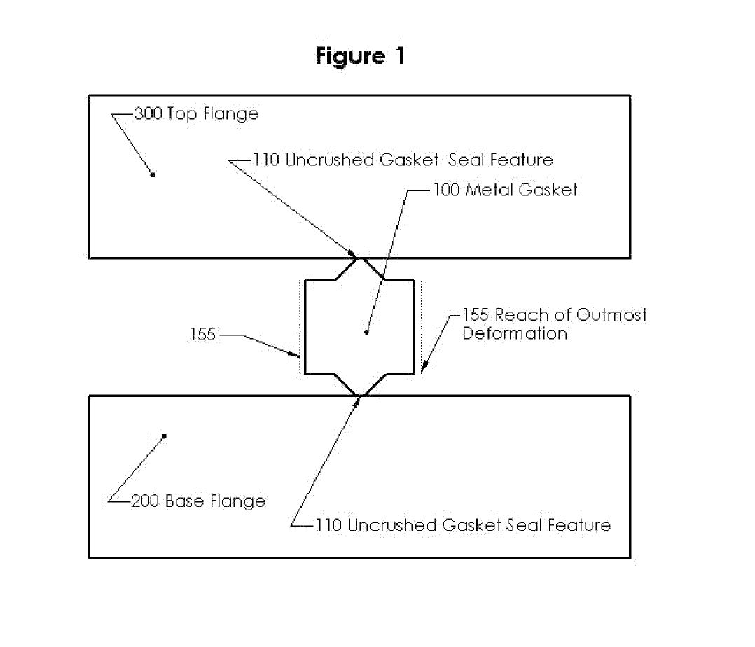

FIG. 1 shows the simple state of the 100 crushable gasket before being crushed between flange plates 200 and 300. As an opposing metal surface 201 and 301 drawn down on top of the gasket the gasket deforms and creates a vacuum barrier between flanges 200 and 300.

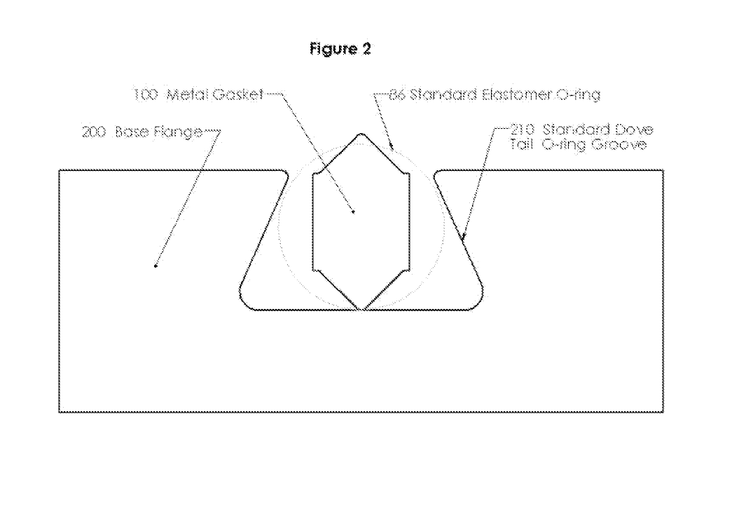

FIG. 2 shows the cross section of a crushable metal gasket designed for use in existing dovetail O-ring grooves. The gasket is rectangular sided to ensure that the gasket may be extracted from the O-ring groove after use.

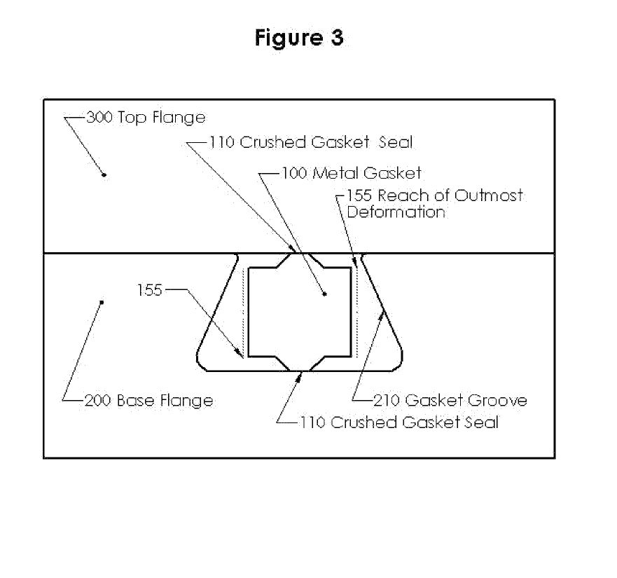

FIG. 3 shows the metal gasket 100 when installed in dovetail 210 O-ring groove similar to FIG. 2. The gasket is first formed to match the shape and dimensions of the receiving O-ring groove so that it may be installed by the user without any alterations to either the chamber or the gasket. The invention is specifically designed in such a manner that as stress builds upon the 110 Crushed gasket seal, they do not cause deformation in the bulk of the gasket beyond the 155 maximum allowable gasket width dimension. This is so it may be extracted from the 210 groove after being crushed between the 200 and 300 flanges due to use.

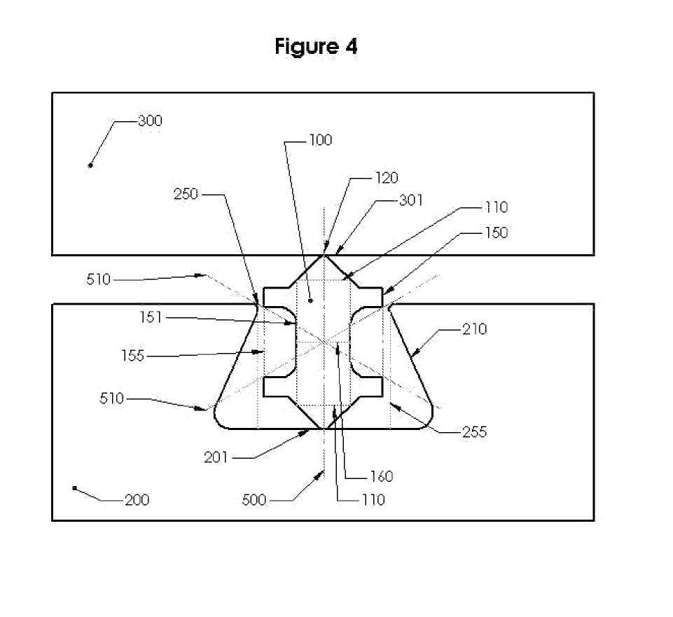

FIG. 4 shows the 100 is the Metal Gasket in a 210 dove tail shaped o-ring groove. It has two large 151 cut outs (reliefs) that enable the metal displaced during compression of the 110 crushed gasket seal to fill. This helps keep the width profile 155 only slight beyond the outer width edge of the gasket 150. This enables the gasket to be removed after use and not be trapped by the constricted throat 250 or interfere with the 255 minimum groove wall.

FIG. 4 also shows the 160 compressive force limiter which deforms (yields) as the 110 crushed gasket seal face widens under an increasing level of compressive force. This 160 limiter serves to reduce the maximum stress in the gasket and stress on the mating flanges 200 and 100. As the compressive force flattens 120 tip it grows to the size of the line shown in 110. Beyond that point, the deformation tends to occur in the 160 compressive force limiting feature.

Also shown in FIG. 4 are vectors where the displaced metals tend to flow 510. They are located on 60 degree angles (510) at the center of the central vector of compression 500 on each side of the 100 gasket.

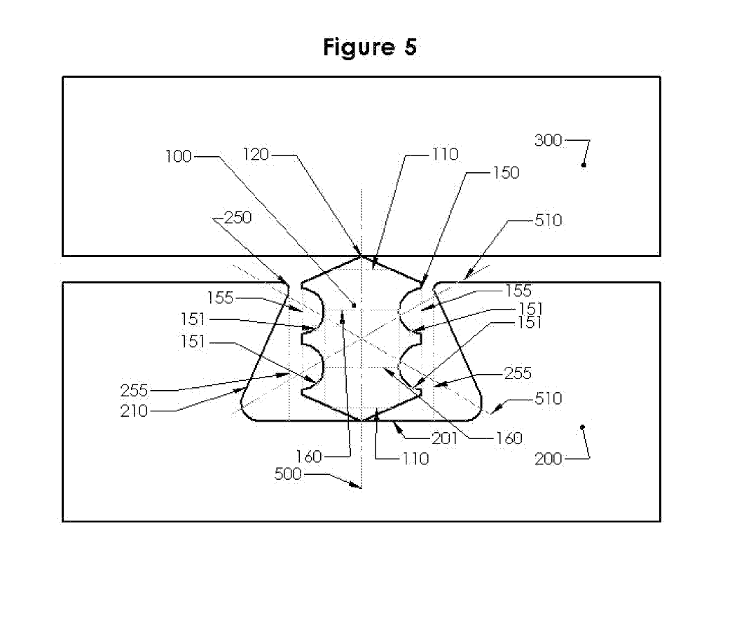

FIG. 5 shows the 100 is the Metal Gasket in a 210 dove tail shaped o-ring groove. It shows the 110 crushable wedge-shaped surface with a 120 degree compression angle which demonstrates the shape-agnostic attributes of the deformable metal wedge 120 that initially concentrates stress on the sealing surfaces 201 and 301 of the flanges.

FIG. 5 shows a version of the 100 gasket with two 151 cut-out reliefs. This demonstrates that the reliefs may be embodied a large number of ways. Also shown in

FIG. 5 are vectors where the displaced metals tend to flow 510. They are located on 60 degree angles (510) off the central vector of compression 500. FIG. 5 also shows the 160 compressive force limiter in two places which deforms (yields) as the 110 crushed gasket seal face widens under an increasing level of compressive force. This 160 limiter serves to reduce the maximum stress in the gasket and stress on the mating flanges 200 and 300.

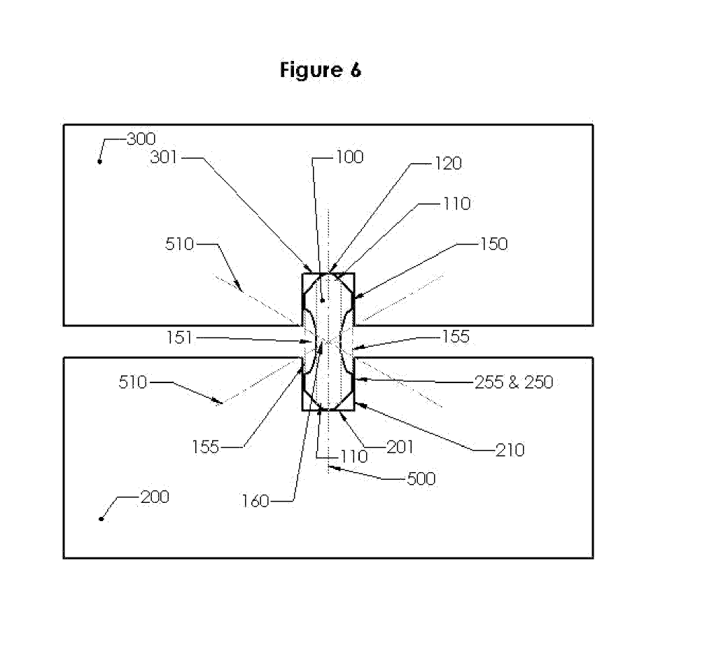

FIG. 6 shows the 100 is the Metal Gasket in its uncompressed state in straight shaped grooves 210. It shows the 110 crushable wedge shaped surface with narrower shape profile which demonstrates that the width of the gasket may be varied. FIG. 6 shows the narrow profile of the 160 compression limiter. It also shows the 151 cut-out relief that encompass both 60 degree slip planes of deformation in one 151 cut-out per side.

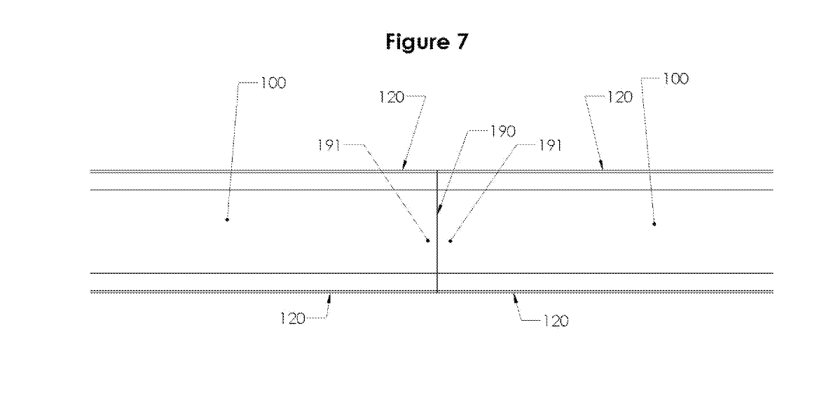

FIG. 7 shows the 190 joined seam between ends 191 of the 100 metal gasket seal. The 190 joint enables the 100 gasket to be formed a continuous hermetic ring from long extruded bars or wires.

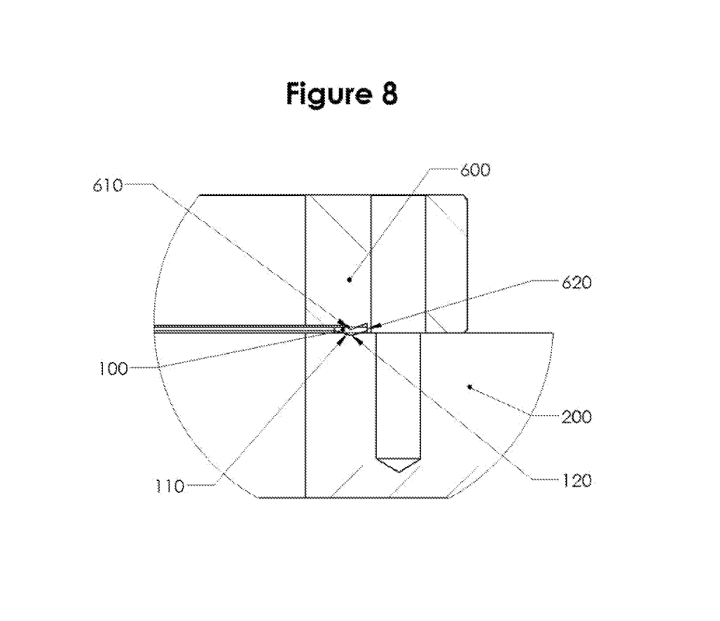

FIG. 8. shows a modified all metal gasket 100 pinched by a knife edge of a Conflat flange and pressed against a flat metal plate 200. The 100 all metal gasket has a flat surface on the 600 Conflat flange side which is pinched by the knife edge 610 and held within the gasket retaining well 620 on the Conflat flange 600. The 120 gasket tip is deformed by the downward compressive forces becoming flatted to the 110 ompressed gasket profile.

Referring to FIGS. 1 through 8, in general terms, the invention comprises one or more of the following features:

1. A metal gasket defining two stress concentrating features that deform upon compression against flange 200 and 300. The stress concentrating features may comprise a sharp point or dull lump that focuses the compressive force upon itself beyond its elastic deformation strength limit.

2. A metal gasket that has been joined to form a continuous hermetic perimeter around mating flanges 200 and 300.

3. A metal gasket that has no internal or external frame.

4. A metal gasket that does not include a separate internal metal spring member.

5. A metal gasket having a defined shape that may be compressed along its vector of compression and that may absorb the displaced metal material in its body such that it does not considerably extend beyond its uncompressed outermost width profile (perpendicular to the vector of compression). This may be done either by minimizing the size of the deformable metal wedge or by storing the displaced metal in reliefs (cut-outs) that are located inside the outer most width profile dimension (155).

6. A metal gasket that is located (or positioned) by grooves on one flange face or both flange faces. After being fully compressed, the displaced metal still does not protrude considerably beyond its outermost uncompressed width profile dimension (155).

7. A metal gasket having a compressive force limiter. A compressive force limiter is a necked or narrowed section of the gasket that deforms upon a critical level of compressive stress. The compressive force limiter limits the stress and deformation at the sealing surface and instead directs the deformation into the necked section of the gasket.

8. A metal gasket that is located (or positioned) on a flange face by conventional elastomeric o-ring grooves. After being fully compressed, the displaced metal still does not protrude considerably beyond it outermost uncompressed width profile dimension.

9. A metal gasket with cut-outs or reliefs that are located in approximate 60 degree increments from the center of the central axis of compression (vector of compression). The cutouts or reliefs may be merged such that both of the 60 degree axis on each side of the gasket are formed into one central cut-out feature. The cut-outs store the displaced metal from the deformed sealing edges or the compressive force limiter and prevent the gasket from getting wider than the uncompressed maximum width profile of the gasket.

10. A metal gasket with guide edges on its width profile that keep it located it within grooves on one or both mating flanges.

11. A metal gasket with a narrow profile that not only deforms along its vector of compression, but also is able to rock laterally. This permits a flange of one coefficient of thermal expansion (CTE) to be hermitically sealed with a flange of another coefficient of thermal expansion (CTE) when both flanges are heated or cooled.

### ALTERNATE EMBODIMENTS

The invention may be used in more sealing applications than vacuum, such as high pressure applications where metal seals enable better seals. For example, pressurized gas or liquid that would otherwise corrode, degrade or permeate through an elastomeric seal could be stored in the same container with the new metal seal. Additionally, new vessels that are designed for UHV may eschew more expensive metal sealing techniques with complicated frame structures and instead machine simple grooves on sealing faces. The gasket used as an adapter to seal conventional Conflat flanges directly to flat metal plates.

### INDUSTRIAL APPLICABILITY

It is clear that the inventive nature of this application has wide applicability to the scientific, semiconductor, particle physics, petrochemical industries and more, namely to provide the ability to use all metal seal gaskets to reduce permeation with simple flexible geometries.

It should be understood that various modifications within the scope of this invention may be made by one of ordinary skill in the art without departing from the spirit thereof and without undue experimentation. This invention is therefore to be defined as broadly as the prior art will permit, and in view of the specification if need be, including a full range of current and future equivalents thereof.

### Parts List

100 is the compressed all metal gasket. 110 is the crushed sealing face of the gasket against the 200 Base Flange and 300 Top Flange.

120 is the wedge shaped deformable feature that creates the vacuum seal. It located against the top flange and the bottom or base flange.

150 is the side (both inside and outside) of the seal that.

151 is the relief or reliefs that provide an empty area which can be filled with the displaced gasket material when the gasket is compressed against the flange sealing faces 201 and

301. The reliefs may be any shape or number. There can be one or more reliefs. The reliefs may be large or small.

155 is the gasket width profile. This is where, when the gasket is compressed, little of the displaced gasket material is permitted extend beyond the boundary.

160 is the compressive force limiter. When the compressive force builds upon the compressed sealing face 110, the force become distributed upon a wider and wider compressed sealing face profile 110. When the compressed sealing face profile 110 becomes as wide as the width of the 160 compressive force limiter the compressive force limiter yields rather than the 110 gasket sealing face.

190 is the permanent joint between the ends 191 of the 100 gasket.

191 are the ends of the gasket length.

86 is the uncompressed profile of a typical elastomeric round o-ring seal.

200 is the base flange. We have defined it as the flange with the gasket groove.

210 is the gasket grove which is located in the base flange (200).

250 is the restricted throat of the gasket groove.

255 is the throat profile that which defines the strict outer limit for the displaced gasket material.

300 is the top flange which is the other sealing member.

500 is the vector of compression against the metal gasket.

510 are the vectors of displacement. For face centered cubic (FCC) structured metallic crystal structures, the slip planes tend to be greatest along 60 degree angles off the vector of compression (500). The displaced aluminum reliefs are located so that the displaced aluminum is stored in the reliefs 151 this minimizes the increase in the gasket width 155.

600 is a conventional ConFlat flange with a knife edge sealing feature.

610 is the knife edge sealing feature on the Conflat flange.

620 is the gasket well that retains the gasket in the Conflat flange.

1. An all-metal gasket system for sealing vacuum with very low permeation comprising:
a soft, malleable metal gasket of aluminum, copper, nickel, tin, silver, gold or other metal:
wherein said metal gasked has a hardness of <70 Rockwell B Scale (100 kg 1/16″ Ball), a yield strength of 20 to 220 MPa and a vapor pressure of <1×10−8 Ton at 600 K.

2. The system of claim 1, wherein the metal gasket is formed into a continuous ring-shape.

3. The system of claim 1, wherein the continuous ring-shape is substantially the shape of an O-ring.

4. The system of claim 1, wherein the metal gasket is coated to alter its hardness and/or deformation qualities.

5. A vacuum chamber comprising:
a chamber having an opening and further including a flange portion around said opening;
a cover shaped and dimensioned to fit over said opening in said chamber and including a flange portion opposite said flange portion of said chamber; and
a soft, malleable metal gasket of aluminum, copper, nickel, tin, silver, gold or other metal positioned between said flange portion of said chamber and said flange portion of said cover;
wherein said metal gasked has a hardness of <70 Rockwell B Scale (100 kg 1/16″ Ball), a yield strength of 20 to 220 MPa and a vapor pressure of <1×10−8 Ton at 600 K.

6. A method of improving the performance of a vacuum chamber of the type having an opening, a cover for closing said opening and an O-ring for effecting a seal between said cover and said opening, said method comprising the step of replacing said O-ring with a a soft, malleable metal gasket of aluminum, copper, nickel, tin, silver, gold or other metal, wherein said metal gasked has a hardness of <70 Rockwell B Scale (100 kg 1/16″ Ball), a yield strength of 20 to 220 MPa and a vapor pressure of <1×10−8 Ton at 600 K.
